(19) United States
(12) Patent Application Publication
(10) Pub. No.: US 2012/0055075 A1
(43) Pub. Date: Mar. 8, 2012

(54) Insect Controlling Devices and Methods

(76) Inventors: Constanze Winkler, Heidenheim (DE); Herman L. Friend, Rockville Center, NY (US); Antoine Biron, Paris (FR); Jie Shan Zheng, Guangzhou Shi (CN)

(21) Appl. No.: 13/193,308

(22) Filed: Jul. 28, 2011

(30) Foreign Application Priority Data
Jul. 29, 2010 (DE) 20 2010 010 823.3

(51) Int. Cl. A01M 1/14; A01M 1/02; A01M 1/20; A01M 99/00

(52) U.S. Cl. 43/114; 119/712; 43/132.1

(57) ABSTRACT

A 3D insect device is described which comprises a preferably water-resistant body that can assume a folded position and then unfolded to expand into a true 3-dimensional structure with one or more elements to either attract or repel flying nuisance and pest insects like flies, mosquitoes, moths, beetles etc or to attract beneficial insects. The structure preferably simulates comparable shape, size and color as occurring in nature, having significant effects on the instincts of the target insects. The 3D device shape is supplemented with one or more of insect attractant colors, tacky agents, food attractants, pheromones, fragrances and aromas, insecticides, and repellents. Water-resistant, preferably biodegradable materials permit both indoor and outdoor use. The device design significantly improves convenience of use while reducing unintended contact of non-targets such as users, children, pets or wildlife with the contact surfaces.

### CROSS-REFERENCE TO RELATED APPLICATION

This application claims priority from German application serial no. DE 20 2010 010 823.3, filed Jul. 29, 2010, which is hereby incorporated herein by reference in its entirety.

### BACKGROUND OF THE INVENTION

1. Field of the Invention

The present invention relates to insect controlling devices. More particularly, the present invention relates to insect controlling devices that can assume a flat structure and then be expanded into a three-dimensional stable design.

2. State of the Art

Insect pests, nuisance insects and beneficial arthropods of the orders Apterygota, Diptera, Lepidoptera, Coleoptera, Homoptera and Heteroptera have been known to man for a long time. Individual species of those orders pose problems when they multiply significantly and thus occur in vast numbers, massively accumulating in a location used or cultivated by man; for example this can even be true for beneficials like ladybugs. An unlimited population increase of flying insects—supported by biotic or biotic parameters—triggers insect control counter measures especially when insect species are causing painful bites, are transmitting diseases or if loss of harvests are likely.

Surveying the development of insect population dynamics—commonly described as monitoring—is important for control measures in the direct or indirect reduction of insect population densities. In many cases the use of pesticides is however often problematic for its adverse side effects on consumers and because of possible residues in soil, water and air. The global weakness of bee populations and their increased loss of orientation is also believed to be linked to excessive use of chemical insecticides and their residues in host plants.

Systems for controlling flying insects have been known for a long time. In the past, for instance, fruit juice or food baited traps were used to allow mass trapping of pest populations. More recently, more modern traps have been baited with e.g. synthetic sex or aggregation pheromones to mass trap insects or to monitor population dynamics of the targeted insect pest species. Light traps have been used in both indoor and outdoor conditions making use of the emitted UV-spectrum, which insects generally need for orientation and to navigate in the dark. It was observed that insects prefer round-shaped light sources rather than elongated light tubes, which was explained by their natural behavior and their instincts by following the sun or the moon. For instance Silvandersson made limited use of this effect as described in U.S. Pat. No. 6,438,894 B1 and WO9842186 (A1)—proposing to print 3D patterns (circular-shaped objects like sun, moon etc.) on an effectively 2D structure, applying shadow and luminescent effects onto flat sticky surfaces. The purpose of his invention was to link cost effective, convenient printed traps with increased efficacy and distinction aiming to deceive the insects in their natural behavior. Inventions like the one of Cook et al. (U.S. Pat. No. 5,713,153) and U.S. Pat. No. 442,624 A are describing the link of a specific attractant with an adequate housing. However his housings do not at all reflect the insect's instinctive needs including important visual three-dimensional stimuli. A cylindrical trap as disclosed in EP 475 665 (Agrisense) is directed at the effects of light and dark stripes having a positive effect on moths but the design of the trap body follows more practical characteristics rather than natural ones. The same for a trap to capture flies as described in EP 446 464 (Bayer)—a practical cubus with lines of a specific red color. Houseflies in homes however gather at the window rather than around the window sill and in front of it. They also prefer roundish, sun-shaped fly bait images positioned directly at the window. Patent DE 60202879 T2 describes three-dimensional structures but the state-of-the-art is not able to sufficiently imitate shape, size and color of fruit or blossoms or other shapes attractive for flying insects. The system is purely for killing insects and thus lacks any type of grid allowing monitoring of captured insects. Patent WO 01/78502 (ECS Environment Care Systems) indeed describes innovative color systems, but here again only flat two-dimensional monitoring and mass trapping insect systems are being claimed.

### SUMMARY OF THE INVENTION

A 3D insect control device is provided and comprises a water-resistant body that can be unfolded and expanded from a folded configuration into a true 3-dimensional structure with one or more elements that either attract or repel flying nuisance and pest insects like flies, mosquitoes, moths, beetles etc or to attract beneficial insects. The control device structure preferably simulates at least one of comparable shape, size and color as occurring in nature, having significant effects on the instincts of the target insects. In one embodiment, the 3D device shape of a fruit is supplemented with insect attractant colors, and one or more of tacky agents, food attractants, pheromones, fragrances and aromas, and insecticides. In another embodiment, the 3D device in the shape of a fruit is supplemented with insect repellents. In a further embodiment, the insect control device is formed from a water-resistant, preferably biodegradable material that permits both indoor and outdoor use. The device is preferably axisymmetrical, and when expanded, defines a plurality of chambers reaching towards the center of the device. The chambers present functional surfaces on which the tacky agents, food attractants, pheromones, fragrances and aromas, insecticides and/or repellents are applied. The outer edges of the chambers which define the circumference of the device are preferably free of the tacky agents, food attractants, insecticides, etc. additive, thereby reducing unintended contact of non-targets such as users, children, pets or wildlife with the contact surfaces. Thus, in one embodiment a device is provided that is able to control flying insects effectively without causing any risks to experienced or inexperienced users of such systems and to the environment.

### BRIEF DESCRIPTION OF THE DRAWINGS

FIGS. 1a-1c are perspective views of a first embodiment of the invention in a closed flat position, a half open position, and a fully open position.

FIG. 1d is a close-up broken view of a portion of the device of FIGS. 1a-1c showing the chambers and application of an insect attractant, repellent, insecticide, and/or tacky agent.

FIG. 2 is a bottom view of a second embodiment of the invention highlighting different shaped openings in the chambers of the device.

FIGS. 3a and 3b are perspective views of a third embodiment of the invention in a closed flat position and a fully open position.

FIGS. 4a and 4b are perspective views of a fourth embodiment of the invention in a fully open position, with FIG. 4a showing the fourth embodiment when first placed in its environment, and FIG. 4b showing the fourth embodiment after a period of time of use in its environment.

### DETAILED DESCRIPTION OF THE PREFERRED EMBODIMENTS

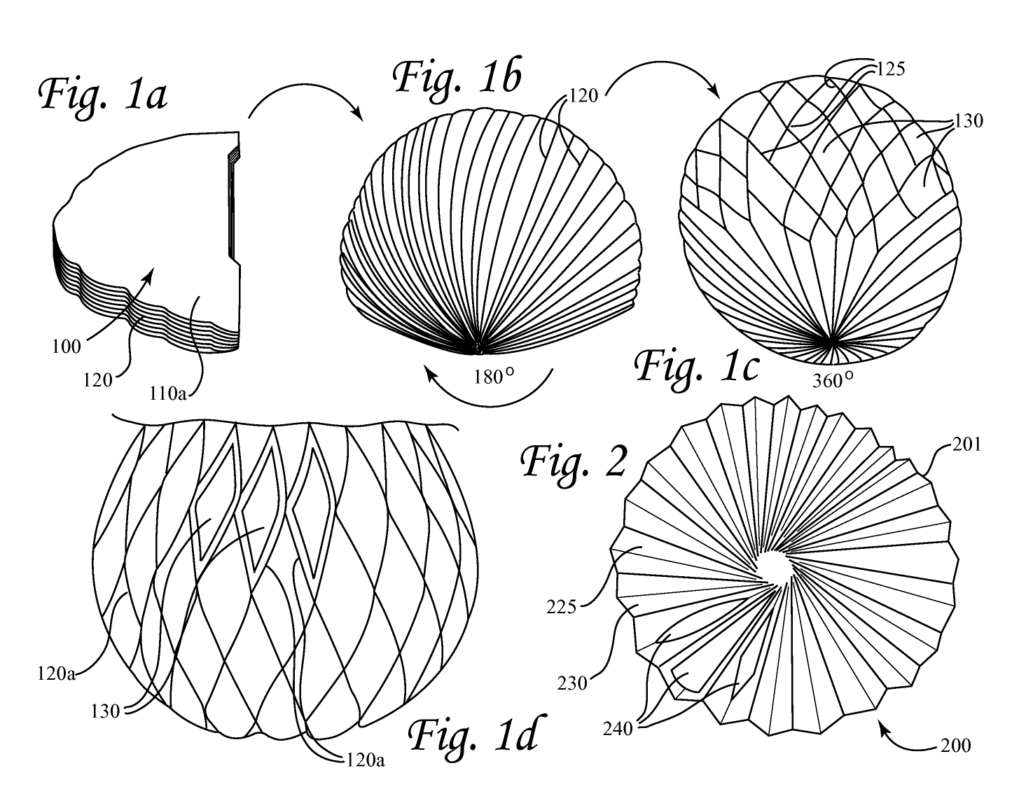

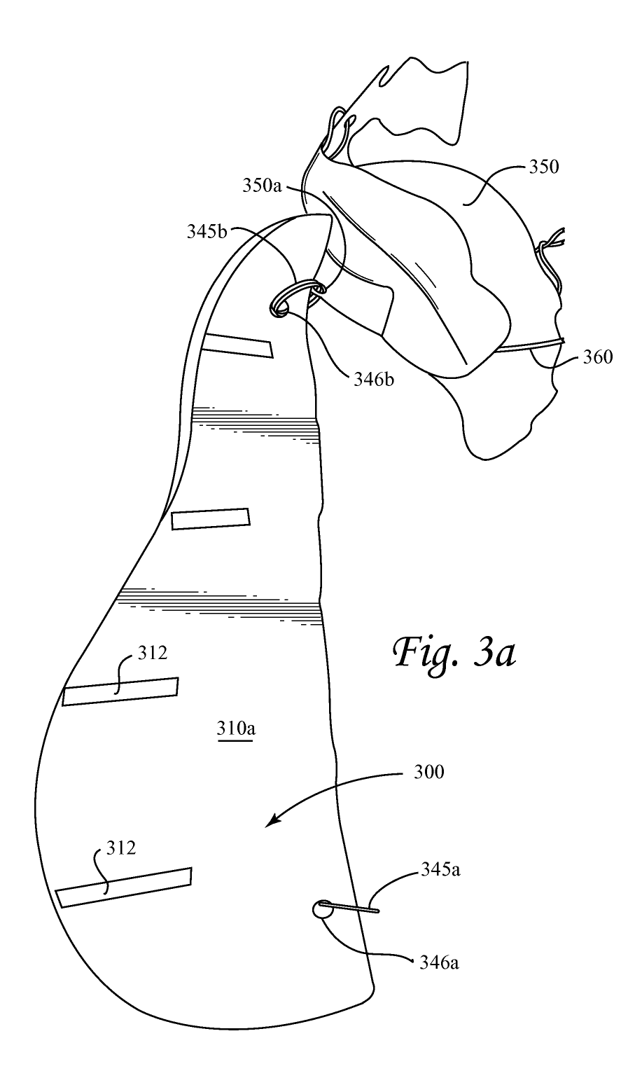

A first embodiment of an insect controlling device 100 is seen in FIGS. 1a-1c. As shown, an insect controlling device 100 is capable of assuming (e.g., being folded into) a substantially flat folded position (FIG. 1a), and of assuming (e.g., being partly unfolded (FIG. 1b) and completely unfolded (FIG. 1c) into) a 3-dimensional shape. Device 100 is preferably provided with a split backbone 110a, 110b (only 110a shown) or end sheets, and a plurality of body sheets 120 therebetween. The body sheets 120 are attached to each other at a plurality of locations and first and last body sheets are attached to the backbone in a manner as is known in the crepe-paper arts such that one (or both) backbone can be rotated about a central axis L to partially and fully open the device 100. When fully open, if desired, the device may be held open using clips, tape, adhesive, or other securing means (not shown). When fully open, the device 100 is substantially spherical and presents a plurality of chambers 130 defined by the sheets 120. The chambers 130 narrow from the outer “surface” of the sphere as they extend toward the closed middle of the sphere. As seen in FIG. 1c, they assume the shape of a rhombic prism with functional surfaces 125 as described below. If desired, the functional surfaces 125 can define openings (not shown) of one or more shapes as will be described with reference to another embodiment. Such an arrangement can be useful if the middle of the sphere is arranged to be open.

According to one embodiment of the invention, the insect controlling device the present invention is water-resistant. Thus, in one embodiment, the body sheets 120, and optionally the backbone 110a, 110b are made from polymeric (film-like carrier) materials. Any suitable polymer known in the field of plastics may be used including Polyvinyl chloride (PVC), Polyacrylonitrile (PAN), Polyacrylates (PC), Polyesters (PES), Polyethylene terephthalate (PET), Polypropylene (PP), Polyethylene (PE), Nylon/Polyamide (PA), Ethylene-vinyl acetate copolymers (EVA), Polyvinyl pyrrolidone (PVP), Polyvinyl alcohol (PVA) etc., blends of the above and others. By adding specialty additives to the polymers known to the expert skilled in the art of polymer chemistry, they may be rendered substantially biodegradable, bio-erodable or compostable.

According to another embodiment the body sheets 120 and optionally the backbone 110a, 110b are formed from waxed or siliconised paper or any other water resistant flat material.

According to one aspect of the invention, the insect controlling device 100 is preferably adapted to provide visual stimuli for the insects of interest. In particular, it is desirable for the device 100 to make use of the instinctive needs of adult insects whose main visual stimuli are known to be based on natural shapes and colors for navigation (e.g. yellow sun or a bright moon) or for detection of host plants, their flowers and fruits (e.g. green apple, a yellow cherry, a red tulip blossom) which insects visit for egg-laying, pollen collecting or harborage. Thus, the body sheets 120 are preferably provided with one or more colors of various nuances. For example, specific blue color tones are known to attract thrips, whereas yellow coloring in different shades is known to be attractive to, for instance, white flies, fungus gnats, cherry fruit flies, some leaf miners and many aphids species. Beneficial insects such as honey bees, bumble bees, lace wings or lady bugs are attracted by colors as naturally presented by flowering plants. Mosquitoes are attracted by dark or black colors in round-elongated structures in which they hide before they emerge to suck blood. Other color triggered attraction effects are possible and repellent effects of colors are known as well. The expert skilled in the art of pigments knows that colored pigments can be part of the granular polymer in the process of making the films or even before. The films can be painted or dyed later on with the target color, or adhesive layers (described hereinafter) may be loaded with color pigments. Colors include the whole known spectrum of nuances including fluorescent and phosphorescent pigments. To support monitoring, colored or uncolored surfaces can be provided with lines to form grids, thereby facilitating counting of insects captured in the chambers of described device.

As previously mentioned, the sheets 120 form chambers which present functional surfaces 125; i.e., comparatively large contact surfaces. The functional surfaces can hold substances that can attract, or repel, or capturing flying insects.

In one embodiment the functional surfaces 125 are treated with attractant chemical ingredients. One class of such attractants is based on insect sex pheromones. These currently being chemically synthesized and generally showing a very specific reaction in the targeted insect species—for instance in imitating a calling female. Examples of these semiochemicals are Z-9-TRICOSENE for the target insect species housefly (Musca domestica); Z,E-9,12-TETRADECADIEN-1-OL for the indian meal moth (Plodia interpunctella); OCTENOL (unspecific) for mosquitoes; E,E-8,10-DODECADIEN-1-YL ACETATE for codling moth (Cydia pomonella); Z-8-DODECENYL ACETATE for red plum maggot (Grapholita funebrana); E,Z-7,9-DODECEN 1-YL ACETATE for european grapevine moth (Lobesia botrana); E,Z-8,10-TETRADECA-8,10-DIENAL for the horse chestnut leaf miner (Cameraria ohridella). However, there is still a significant number of species for which pheromones have not been discovered and/or which are too expensive or complicated to be synthesized or play a minor role in the communication between the sexes of a particular insect species. In those (and other) cases, food attractants based on fragrances, flavors and aromas such as sucrose or fructose based carbohydrates, molasses, honey and formulations thereof may be used: e.g., 9-DECENAL; 8-UNDECEN-1-AL; cis-7-DECEN-1-AL; 2,6-DIMETHYL-5-HEPTEN-1-AL; trans-4-DECEN-1-AL; cis-6-NONEN-1-AL; cis-3-HEXEN-1-AL; ETHYL CIS-3-HEXENOATE; 3,7-DIMETHYL-2,6-OCTADIEN-1-AL; 2,4-DODECADIEN-1-AL; 2,4-UNDECADIEN-1-AL; trans-2-HEPTEN-1-AL; trans-2-OCTEN-1-AL; E,Z-2,6-DODECADIEN-1-AL; 3,6-NONADIEN-1-YL ACETATE. They are used to attract nuisance or pest insect species such as fruit fly (Drosophila melanogaster), common wasps (Vespula vulgaris) and others. As previously mentioned, diptera like white flies (Trialeurodes vaporariorum) or cherry fruit flies (Rhagoletis cerasi) and some coleoptera species (beetles) are primarily attracted by colored devices to which attractive fragrance can be added. The expert skilled in the art of chemical attractants knows that most of the known and listed compounds can be extracted from plants or organic sources as occurring in nature. Often extraction processes are less economical but qualities (for example documented by the same CAS number) can be entirely identical for both chemical and natural substances.

In another embodiment, the functional surfaces 125 are treated with insect repelling agents which are time released from the device over an extended period. Repellent substances are known to experts in the art of this chemistry. Among others those can be oils of Citronella, Peppermint, Cedar, Lemongrass, Soybean or substances like 1,8-cineol (1,3,3-trimethyl-2-oxabicyclo[2.2.2]octane); Para-menthane- 3,8-diol (PMD); Citronellol (3,7-dimethyl-oct-6-en-1-ol); Citronellyl acetate (acetic acid 3,7-dimethyl-oct-6-enyl ester); Linalool (3,7dimethyl-octa- 1,6-dien-3-ol); [beta]-pinene (6,6-dimethyl-2-methylene-bicycIo[3.1.1]heptane); [alpha]-terpinol (2-(4-methyl-cyclohex-3-enyl)-propan-2-ol); d-limonene (4-isopropenyl-1-methyl-cyclohexene); citronellal (3,7-dimethyloct-6-en-1-al); Geranial (3,7-dimethyl-2,6-octadienal) or Geraniol (3,7-dimethyl-2,6-octadien-1-ol). Unsaturated alcohols including I-octen-4-ol and 1-nonen-3-ol are known to be useful in repelling the housefly Musca domestica and the mosquito species Aedes aegypti.

According to another embodiment of the invention, the functional surfaces 125 are treated with insecticides known to the person skilled in the art for killing insects. The used insecticides can be of chemical or natural origin, acting on contact or by ingestion.

In the given device, insecticide use only applies to noxious insects or insect pests as targets.

It will be appreciated that functional surfaces 125 may be treated with any combination of the attractants, repellents, and insecticides, as desired.

In addition to the attractants, repellents, and insecticides, the functional surfaces 125 of the chambers of the insect control device 100 may be treated with a glue or adhesion agent for tacking the insect to the device. It is important to note that this aspect is not to be confused with any adhesive which might be used to form the final shape and design of the structure of the device. Rather, this adhesion agent has the function of capturing and holding the flying insects once they have visited and contacted the chambers of the controlling device 100. The tack properties are of a non-permanent type; such adhesives are popularly known as “wet or cold glues”. Adhesives of this type can for instance be resin-based with additives to reduce or increase the tack, be completely natural and are known and designed to keep their wet-type features. Those skilled in the art know that these types of adhesives do not age or dry out as a function of time.

Alternatively, as long as the tack is maintained, adhesives or wet glues can also be replaced by any oily, greasy substances able to form a layer. Those substances are ideally natural or nature-identical and can be based on vegetable sources like peanut, soybean, olive, canola, rape, coconut or any other organic source. The tacky adhesion agents are ideally forming a thick enough layer into which the insect sinks in so they are permanently captured. Thus, the device can be pre-equipped with the “wet glue” located inside the chambers or is offered in a set of controlling device plus glue spray (aerosol or pump). The treated chambers can be coated with the glue in a continuous layer or they may present as gaps in the layer being free of adhesive.

According to one embodiment of the invention, and as seen best in FIG. 1d, the functional surfaces 125 of the chambers of device 100 are treated with attractant, repellent, insecticide, and/or sticky agent at locations 130 away from the outer edges 120a of the sheets 120. Thus, by way of example only, the treatment area of the functional surfaces 125 may be located 1 mm or more away from the outer edges 120a of sheets 120. In this manner, the device 100 can be handled on its surface, i.e., at the outer edges 120a, without unintended contact with glue or insecticide by users. In addition, by locating the treatment area away from the outer edges 120a, unintended contact by children, pets or wildlife with the treatment element (e.g., insecticide or sticky agent) can be avoided.

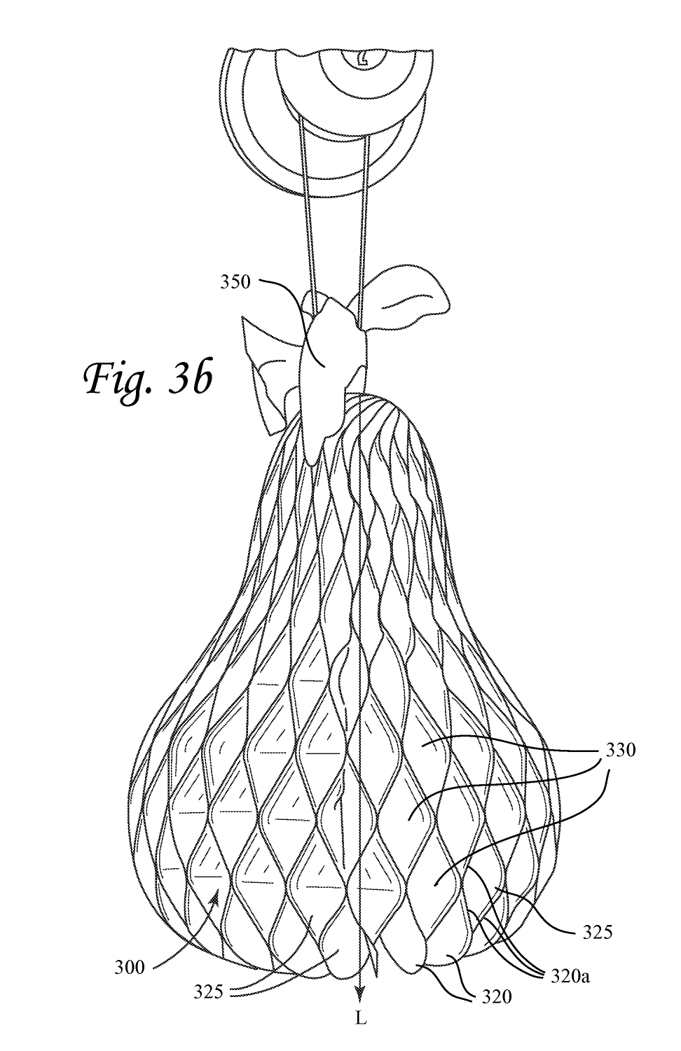

A second embodiment of an insect controlling device 200 is seen in FIG. 2. As shown, device 200 is a 3D device with a hollow center. Device 200 has a bottom 201, a top (not shown) that is substantially identical to the bottom 201, and a body (not shown) with either a pleated generally cylindrical sheet arrangement (not shown) or a radially extending sheet arrangement attached to the bottom 201 and top. Device 200 may be collapsed into a much smaller cylinder by twisting the device. Device 200 provides chambers 230 with functional surfaces 225 as well as chambers between the body sheets (not shown). In addition, openings 240 may be provided in the functional surfaces 225. The openings may be of the same or of different shapes (different shapes being shown in FIG. 2) and may provide for a passage from the outside into a hollow middle of the device 200. The middle of the device may include a small diameter cylinder (not shown) that is coated with sticky agent on its outer surface and/or on its inner surface.

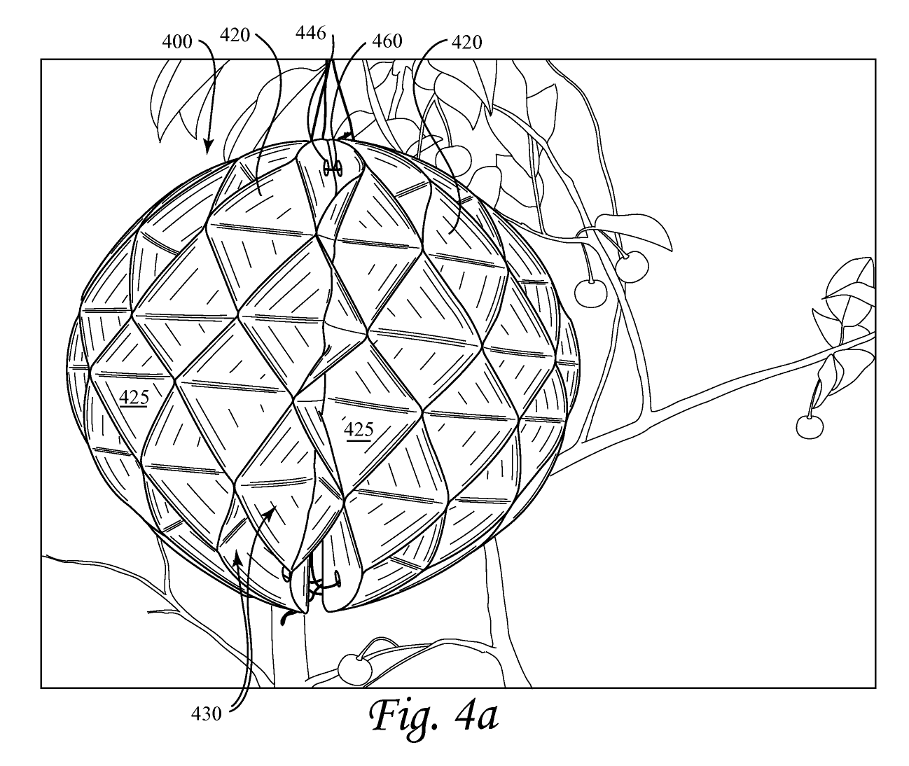

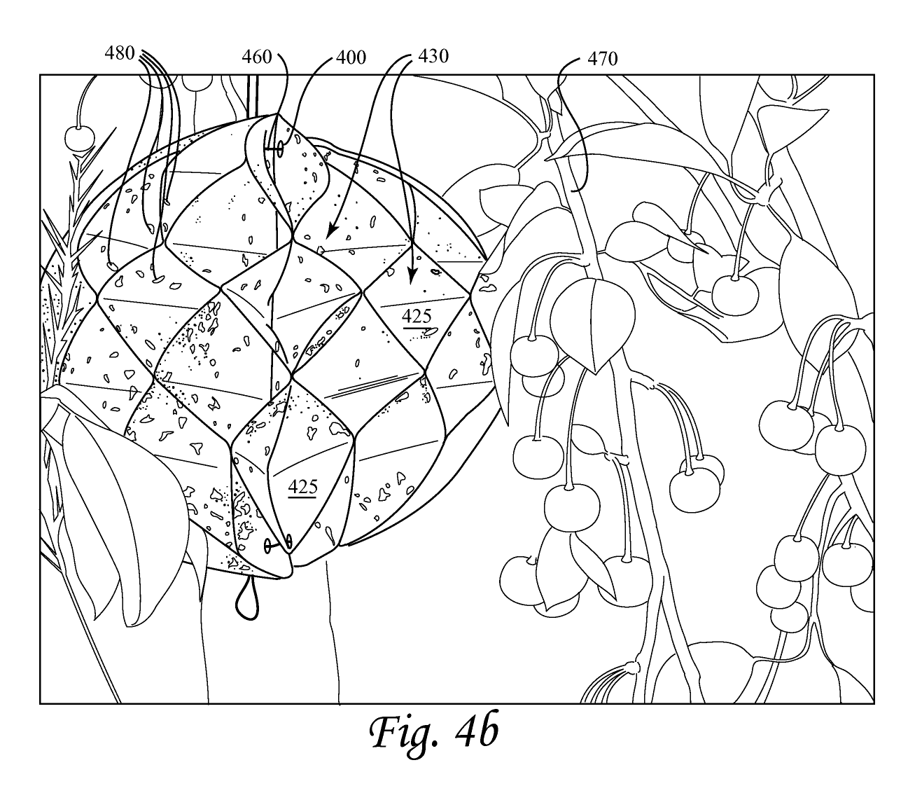

It should be appreciated by those skilled in the art that the openings 240 shown in the embodiment of FIG. 2 may be used in conjunction with the embodiment of FIGS. 1a-1d or the embodiments of FIGS. 3a, 3b and FIGS. 4a, 4b described hereinafter.

A third embodiment of an insect controlling device 300 in the form of a 3D pear is seen in FIGS. 3a and 3b. As shown, device 300 is capable of being folded into a substantially flat position (FIG. 3a), and of being unfolded (FIG. 3c) into a 3-dimensional shape that mimics an actual pear. Device 300 is preferably provided with a split backbone 310a, 310b (only 310a shown) or end sheets with securing strips 312 in the form of double-backed tape attached to one or both of the backbone elements, and a plurality of body sheets 320 between the backbone elements. The body sheets 320 are attached to each other and to the backbone in a manner as is known in the crepe-paper arts such that one (or both) backbone can be rotated about a central axis L to partially and fully open the device 300. When fully open, if desired, the device may be held open by using the tape strips 312. When fully open, the device 300 is substantially axisymmetrical and presents a plurality of chambers 330 defined by the sheets 320. The chambers 330 narrow from the outer “surface” of the axisymmetrical body as they extend toward the closed middle of the body. As seen in FIG. 3b, the chambers generally assume the shape of a rhombic prism with functional surfaces 325. As described above with reference to the device 100 of the first embodiment, the surfaces 325 may be treated with any combination of the attractants, repellents, and insecticides, as desired. In addition to the attractants, repellents, and insecticides, the functional surfaces 325 of the chambers of the insect control device 300 may be treated with a glue or adhesion agent for tacking the insect to the device. Preferably, any treating agent is applied at locations 330 away from the outer edges 320a of the sheets 320. If desired, the functional surfaces 325 can define openings (not shown) of one or more shapes.

As seen in FIGS. 3a and 3b, the device 300 also comprises rings 345a, 345b, leaf ornamentation 350, and an elastic band 360. The rings 345a, 345b extend through holes 346a, 346b defined in the backbone 310a, 310b and body sheets 320, and help facilitate rotation of the backbone 310a and body sheets 320. The leaf ornamentation 350 is also connected to ring 345a via a hole 350a defined in the leaf ornamentation 350. The elastic band 360 may be attached to the leaf ornamentation through a hole (not shown) therein, or otherwise, or to the ring 345a, or directly to the backbone and/or body sheets. With the provided leaf ornamentation, the pear assumes a configuration which very closely mimics an actual pear, and which is suitable for indoor decorative use as well as its functional use. The elastic band 360 permits the device 300 to be hung from any support element such as a door knob, a tree branch, etc. Preferably, the leaf ornamentation 350 is water-resistant. Thus, it may be formed from any water-resistant material such as plastic. Optionally, it may also be treated with chemicals and/or with glue or adhesion agent.

In one embodiment, the body sheets 320 of insect control device 300 are green, and the leaf ornamentation 350 is a deeper leafy green. In another embodiment, the body sheets 320 are yellow or yellow-green, and the leaf ornamentation 350 is a deeper leafy green.

A fourth embodiment of an insect controlling device 400 in the form of a 3D sphere is seen in FIGS. 4a and 4b. Device 400 is capable of being folded into a substantially flat position and of being unfolded as seen in FIGS. 4a and 4b. Device 400 is preferably provided with a split backbone (not shown), and a plurality of body sheets 420 between the backbone elements. The body sheets 420 are attached to each other and to the backbone in a manner as is known in the crepe-paper arts such that one (or both) backbone can be rotated about a central axis to partially and fully open the device 400. When fully open, if desired, the device may be held open by using securing means (not shown) such as tape strips. When fully open, the device 400 presents a plurality of chambers 430 defined by the sheets 420. The chambers 430 narrow from the outer “surface” of the spherical body as they extend toward the closed middle of the body. As seen in FIG. 4a, the chambers generally assume the shape of a rhombic prism with functional surfaces 425. As described above with reference to the device 100 of the first embodiment, the surfaces 425 may be treated with any combination of the attractants, repellents, and insecticides, as desired. In addition to the attractants, repellents, and insecticides, the functional surfaces 425 of the chambers of the insect control device 400 may be treated with a glue or adhesion agent for tacking the insect to the device. In the embodiment shown, the body sheets 420 of the device 400 were formed from yellow plastic (PVC film), and the functional surfaces 425 were treated with a tacking agent (a standard aerosol glue spray comprising hydrogenated terpene resin) to which a cherry fruit fly pheromone (blend of z-7-DECIN-1-YL ACETATE and z-11-TETRADECEN-1-OL from Bedoukian Research, Inc. Danbury, Conn.) was added.

As seen in FIGS. 4a and 4b, the device 400 is provided with an elastic band 460 which extends through holes 446 of the backbone and body sheets 420. The elastic band 460 permits the device 400 to be hung from a tree branch, etc.

FIG. 4a shows the insect controlling device 400 when it was first hung by elastic band 460 from a cherry tree 470. FIG. 4b shows the same insect controlling device 400 later with numerous cherry fruit flies 480 trapped on the functional surfaces 425 of the device 400.

It will be appreciated by those skilled in the art, that the 3D insect controlling devices of the invention may be tailored to suit any of various applications. By way of example only, the 3D insect device may be equipped as follows:

1) desired body shape+adequate attractive color+adhesive, no additional attractant-example: to attract & capture white flies in greenhouses or pot plants;

2) desired body shape+adequate attractive color+sucrose based food attractant-example: to attract & feed beneficial insects to gardens or greenhouses;

3) desired body shape+adequate attractive color+attractant+adhesive-example: to attract & capture codling moths in apple orchards and gardens;

4) desired body shape +adequate repulsive color+repellent-example: to repel mosquitoes from rooms or around homes;

5) desired body shape+adequate attractive color+attractant+insecticide-example: to attract & kill horse chestnut leaf miners in parks and gardens.

There have been described and illustrated herein several embodiments of an insect controlling device. While particular embodiments of the invention have been described, it is not intended that the invention be limited thereto, as it is intended that the invention be as broad in scope as the art will allow and that the specification be read likewise. Thus, while particular shapes have been disclosed, it will be appreciated that other shapes may be used as well. In particular, other fruit shapes may be used, although the invention is not limited thereto. In addition, while particular types of attractants and repelling agents have been disclosed, it will be understood that other attractants and repelling agents can be used. It will therefore be appreciated by those skilled in the art that yet other modifications could be made to the provided invention without deviating from its spirit and scope as claimed.

What is claimed is:

1. An insect controlling device, comprising:
a water resistant structure adapted to have a first folded position in which the structure assumes a collapsed position, and a second unfolded position where the structure assumes an expanded 3-dimensional position where the structure presents a plurality of chambers with functional surfaces reaching towards the center of the structure, said structure having controlling effects on flying insects.

2. An insect controlling device according to claim 1, wherein in said first folded position, said structure assumes a flat position.

3. An insect controlling device according to claim 2, wherein in said second unfolded position said structure assumes the shape of a sphere.

4. An insect controlling device according to claim 2, wherein in said second unfolded position said structure assumes the shape of a fruit.

5. An insect controlling device according to claim 1, wherein at least a plurality of said functional surfaces define openings.

6. An insect controlling device according to claim 1, wherein the functional surfaces are pigmented in a color adapted to attract or repel the flying insects.

7. An insect controlling device according to claim 1, wherein said water-resistant structure in said 3-dimensional position is axisymmetrical.

8. An insect controlling device according to claim 1, wherein said functional surfaces have a tacky or adhesive substance adapted to capture flying insects.

9. An insect controlling device according to claim 1, wherein said functional surfaces have an attractant adapted to lure flying insects.

10. An insect controlling device according to claim 8, wherein said functional surfaces have an attractant adapted to lure flying insects.

11. An insect controlling device according to claim 1, wherein said functional surfaces have an insecticide compound adapted to kill flying insects.

12. An insect controlling device according to claim 1, wherein said functional surfaces have a repelling compound adapted to repel noxious flying insects.

13. An insect controlling device according to claim 1, wherein said water resistant structure is biodegradable.

14. An insect controlling device according to claim 1, wherein at least some of said plurality of chambers have the shape of a rhombic prism.

15. An insect controlling device according to claim 1, wherein said functional surfaces are marked with a grid adapted to facilitate monitoring of numbers of flying insects captured by said controlling device.

16. An insect controlling device according to claim 1, wherein said functional surfaces are treated to control flying insects of at least one of the orders Apterygota, Diptera, Lepidoptera, Coleoptera, Homoptera and Heteroptera.

17. An insect controlling device according to claim 1, wherein said water-resistant structure includes at least one backbone sheet and a plurality of body sheets attached to each other and to the backbone.

18. An insect controlling device according to claim 15, further comprising securing means for keeping said water-resistant structure in said second unfolded position.

19. An insect controlling device according to claim 1, wherein the functional surfaces have outer surface edges, and said functional surfaces are treated with at least one of an attractant, repellent, insecticide, and sticky agent at locations other than at said outer surface edges.
